(19) United States
(12) Patent Application Publication
(10) Pub. No.: US 2010/0209894 A1
(43) Pub. Date: Aug. 19, 2010

(54) HAND-INSCRIBABLE SURFACE AND METHOD

(75) Inventor: Stephen Francis Brehaut, Victoria (AU)

Correspondence Address: Stephen;Brehaut, 45 Joan Avenue, Ferntree Gully, Victoria, 3156, omitted

(73) Assignee: ARICOM PTY. LIMITED, Victoria (AU)

(21) Appl. No.: 12/438,138

(22) PCT Filed: Aug. 20, 2007
(86) PCT No.: PCT/AU07/01172

§ 371 Date: Feb. 20, 2009

(30) Foreign Application Priority Data
Aug. 21, 2006 (AU) 2006904514

(51) Int. Cl. G09B 11/04

(52) U.S. Cl. 434/166

(57) ABSTRACT

A hand-inscribable surface has a pattern on its surface to assist a user to handwrite in correct alignment. The pattern includes an arrangement of linear paths with linear regions in between. The uses writes in the linear regions relying on the linear paths as alignment guides. Within each linear region, there is a separation-boundary that is located between: i) a clear primary linear strip which is substantially devoid of indications and in which clear primary linear strip, in use, a majority of typical handwriting will be inscribed; and ii) at least one secondary linear strip in which only a minority of typical handwriting will be inscribed. The separation-boundary is biased towards one of the linear paths, between which it lies. In other words, the separation-boundary is not located centrally between the linear paths, and the primary linear strip is substantially wider than the secondary linear strip.

### FIELD OF INVENTION

The present invention relates to a hand-inscribable surface, namely, a surface that is written, drawn or otherwise inscribed on by hand. The invention has particular, but not exclusive, application to writing and drawing paper, stationery and surfaces that are written and drawn on.

The present invention also relates to other types of objects that are written on such as blackboards, whiteboards and other such large objects that have hand-inscribable surfaces.

### PRIOR ART

There are sometimes problems when writing, drawing or otherwise inscribing on plain paper, or even on other hand-inscribable surfaces, such as upright blackboards or whiteboards.

A first difficulty is in maintaining alignment of what is written, i.e. keeping the writing generally aligned along a straight horizontal line. For example, when writing on plain paper, often the handwriting tends to slope upwards or downwards. This problem also occurs when writing on upright blackboards or whiteboards. The use of plain un-marked writing or inscribing surfaces all suffer from this difficulty of writing or inscribing in alignment.

A second difficulty is in maintaining consistency of scale with regard to what is hand-inscribed on the surface, i.e. keeping all the letters of similar size or scale.

To avoid either or both of these problems in handwriting, an extremely common solution in the prior art is to provide the inscribing surfaces with prominent straight lines which act as alignment guides. For example, writing paper, such as in writing pads or pages of diaries, are usually provided with horizontal lines. These horizontal lines enable the user to write straight across the page while relying on the lines as a guide for writing. A problem with these prominent lines, however, is that the lines are highly visible, and are unsightly.

The lines are often rendered in a different colour, such as light blue, in order to distinguish from the handwriting, which is often in dark blue or black. However, when the lined-paper is photocopied using conventional black & white copying, the handwriting, as well as the lines, are both reproduced in the same colour. Thus, photocopying causes the lines to become more prominent in the photocopy.

Also, the lines are a distraction when reading what has been written. Such alignment lines are also sometimes provided on blackboards, but this makes it more difficult to read the writing on the blackboard, especially when viewed from a distance.

Similar problems are found in upright hand-writing surfaces, such as blackboards or whiteboards, where it is often even more difficult to write in straight lines and to maintain a consistent scale size. Providing the blackboards or whiteboards with horizontal alignment lines is a poor remedy, because those lines obscure the writing when the viewer looks at the blackboard from a distance.

Another problem with horizontally-lined paper is that these horizontal lines do not assist the user when the piece of paper is rotated by ninety degrees, typically when changing from portrait orientation to landscape orientation. When single-lined paper, intended to be written on in portrait orientation, is rotated into landscape mode, the lines become arranged as parallel vertical lines, and therefore cannot function as writing alignment guides.

In FIG. 1A, a prior art solution is to provide a grid of lines with a cross-hatch appearance, which act as alignment guides for writing when the paper is either in portrait or landscape mode. It also provides a vertical alignment guide in either orientation. Nevertheless, the cross-hatch grid of lines is unsightly, particularly when the paper is subsequently photocopied.

A particular shortcoming of the grid in FIG. 1A is that, when writing along the horizontal lines of the cross-hatch grid, the writing has to be written over the vertical lines of the grid. FIG. 1A shows a piece of paper 1A having an intersecting grid of vertical lines 2 and horizontal lines 3. As a result, the handwriting 4 must be written across the vertical lines 2.

Another example of such disadvantages is seen in U.S. Pat. No. 5,698,297 (Pitts) which discloses a grid pattern used for poster-boards. A significant problem of the cross-hatch grid, comprising intersecting horizontal and vertical lines, is that either one of the set of lines will obstruct the writing on the page. For instance, if a person writes along the horizontal lines, then the vertical intersecting lines will repeatedly and regularly obstruct the person's hand-writing, because the handwriting must be written across the vertical lines.

This problem, of having to write across the linear alignment guide, is also seen in European Patent No. 0,165,917 (Omre) where the paper surface is provided with a grid of linear regions, where the linear regions are created by intersecting lines of dots. The problem remains in the Omre patent, because some of the dots or indications, from one set of lines, are located in the space in between the lines of the other set, i.e. the problem shown in FIG. 1. Hence, the problem is that the writing must be written across the vertical lines. Prior art FIG. 1B shows a piece of paper 1B as per the Omre patent, having the intersecting grid of vertical dotted lines 2 and horizontal dotted lines 3. As a result, the handwriting 4 must be written substantially across the dots in the vertical dotted lines 2.

This same problem is also seen in United Kingdom Patent GB 590,105 (Harding & Beeson). Once again, the paper is provided with an intersecting grid of horizontal and vertical lines, in the form of scale lines. The problem remains that any writing must be written substantially across the vertical scale lines.

FIG. 1C is an attempt, in the prior art, to solve the problem of having to write across the alignment lines. In FIG. 1C, in a region between the main lines, all the dots are removed. This, however, is not a satisfying solution because, as seen in FIG. 1C, there can be a tendency for the handwriting to be misaligned within the boundaries of the main lines 3 (indicated with dotted lines 3). For instance, in FIG. 1C, the handwriting is sloping slightly upwards, going left to right. Also, there can sometimes be a tendency to vary the scale size of the letters, rather than maintaining a consistent scale size.

Discussion of the prior art above is not to be taken as an admission that any one or more of the prior art patents, individually or in combination, are part of the common general knowledge.

An object of the present invention is to substantially overcome or at least ameliorate one or more of the abovementioned problems in the prior art, particularly the problem in the prior art of having to write substantially across the alignment guides.

### SUMMARY OF INVENTION

According to the present invention, there is provided a hand-inscribable surface provided with a pattern on the surface to assist a user to handwrite thereon in correct alignment, the pattern including:
an arrangement of linear paths with linear regions therebetween such that the user is able to handwrite in the linear regions while relying on the linear paths as an alignment guide,
wherein the pattern on the surface includes an arrangement of discrete indications which demarcate, within its linear region, a separation-boundary between:
   i) a clear primary linear strip which is substantially devoid of indications and in which clear primary linear strip, in use, a majority of typical handwriting will be inscribed; and
   ii) at least one secondary linear strip in which only a minority of typical handwriting will be inscribed,
and wherein the separation-boundary is substantially biased towards one of the linear paths, between which it lies,
and wherein the separation-boundary is not located centrally between the linear paths between which it lies.
and wherein the primary linear strip is substantially wider than the at least one secondary linear strip.

Preferably, the primary linear strip takes up substantially more than 50% of the linear region.

Preferably, the separation-boundary acts as a further alignment guide for the upper limit of the curved portions of typical handwriting.

Preferably, the hand-inscribable surface is useable in at least a first and second orientation, wherein the first orientation is rotated with respect to the second orientation.

The first orientation may be rotated by 90 degrees from the second orientation.

The hand-inscribable surface may be rectangular, and the pattern may be operable as defined when the rectangular surface is in either portrait or landscape orientation.

In an exemplary embodiment, in one orientation, some indications lie on the separation boundary,
and wherein, in a second orientation, said some indications lie on a linear path.

Alternatively, the first orientation may be rotated by 45 degrees from the second orientation.

Preferably, when the hand-inscribable surface is in the first orientation, some of the discrete indications which demarcate the separation-boundary are located on the vertical linear paths, and when the hand-inscribable surface is rotated by an amount of degrees into the second orientation, there is a swapping of roles in that the aforesaid discrete indications are then located on the horizontal linear paths wherein they perform the role of defining the horizontal linear path.

The amount of degrees may be ninety degrees.

Alternatively, the amount of degrees may be forty-five degrees.

Preferably, the linear paths are formed as a linear row of dots.

The discrete indications of the arrangement of linear paths may be visually identical with the discrete indications which demarcate the separation-boundary.

The arrangement of linear paths may be formed as a grid-like pattern of discrete indications which lie on the linear paths.

The grid-like pattern of discrete indications may comprise a plurality of perpendicularly intersecting horizontal and vertical linear paths which thereby form said grid-like pattern.

Each intersection of the perpendicularly intersecting horizontal and vertical linear paths may be free of any indications.

Alternatively, some of the intersections of the perpendicularly intersecting horizontal and vertical linear paths may be free of any indications.

The grid-like pattern may include a discrete indication located at some or each intersection of the perpendicularly intersecting horizontal and vertical linear paths.

In some exemplary embodiments, the discrete indication located at some or each of the intersections, along with adjacent indications which demarcate the separation-boundary, together form a V-shaped pattern.

The V-shaped pattern may be defined at alternate intersections of the perpendicularly intersecting horizontal and vertical linear paths.

Alternatively, the V-shaped pattern may be defined at every intersection of the perpendicularly intersecting horizontal and vertical linear paths.

In some exemplary embodiments, all the V-shaped patterns point in the same direction.

In other exemplary embodiments, some of the V-shaped patterns point in one direction while other of the V-shaped patterns point in a different direction.

Preferably, when the handwriting is Roman alphabet, the majority of typical handwriting generally comprises loops and circles of lower-case alphabet, while the substantial minority of typical handwriting generally comprises stems of the lower-case alphabet.

The linear regions may include one or two secondary linear strips.

The pattern of discrete indications may demarcate the separation-boundary between the clear primary linear strip and two secondary linear strips.

The linear regions may include two separation boundaries.

The surface may be a piece of paper, a stationery item or a whiteboard writing surface.

Preferably, all of the discrete indications are in the form of dots.

Some or all of the discrete indications may be in the form of minute symbols including alphabetic characters or numerals.

The indications may be provided in one colour, or a plurality of colours.

### DRAWINGS

In the drawings, FIG. 1A shows an example of a prior art writing surface having an intersecting grid of vertical and horizontal lines, which illustrates the problem of the hand-writing being written substantially across and over the vertical lines.

FIG. 1B illustrates the concept of the Omre patent which has a grid of intersecting dotted lines, in which the problem remains of having to write substantially across the dots in the dotted lines.

FIG. 1C illustrates a problem of misaligned handwriting within the guidelines.

In order that the invention might be more fully understood, embodiments of the invention will be described, by way of example only, with reference to the accompanying drawings, in which:

FIG. 2 shows typical handwriting that has been written substantially between lines on a page.

FIG. 3 shows a first embodiment of a hand-inscribable surface which has solid lines, in between each of which is a separation boundary that demarcates between a clear primary linear strip and a secondary linear strip;

FIG. 4 shows a second embodiment of a hand-inscribable surface which, instead of solid lines, makes use instead of path-dots to indicate the linear paths which are used as writing alignment guides;

FIG. 5A shows a third embodiment of a hand-inscribable surface which can be used in either of two orientations, and where FIG. 5A shows the surface oriented in portrait orientation;

FIG. 5B shows the third embodiment of FIG. 5A oriented differently in landscape orientation;

FIG. 5C is a close-up detailed view of FIG. 5A;

FIG. 6A shows a modified embodiment where every alternate intersection point has a single indication, and every other alternate intersection point has a V-shaped arrangement of indications;

FIG. 6B shows the embodiment of FIG. 6A oriented differently in landscape orientation as a result of rotation by ninety degrees;

FIGS. 6C and 6D are close-up detailed views of FIGS. 6A and 6B respectively;

FIG. 7A shows a another embodiment where indications, that are found on the separation boundary, are rendered in a lighter shade to create visual distinction;

FIG. 7B shows the embodiment of FIG. 7A oriented differently in landscape orientation as a result of rotation by ninety degrees;

FIG. 8A shows a further embodiment in which some of the indications are represented with a different intensity to provide a means of visual differentiation;

FIG. 8B shows the embodiment of FIG. 8A oriented differently in landscape orientation as a result of rotation by ninety degrees;

FIG. 9A shows yet a further embodiment in which the V-shaped arrangements of indications, found at each intersection point, points in a different direction to the arrangement that is found at its next nearest intersection point;

FIG. 9B shows the embodiment of FIG. 9A oriented differently in landscape orientation as a result of rotation by ninety degrees;

FIGS. 9C and 9D are close-up detailed views of FIGS. 9A and 9B respectively;

FIG. 10A shows a further modified embodiment in which the path lines are formed as solid lines, and where, in the separation boundary, only every second or alternate point is provided;

FIG. 10B shows the embodiment of FIG. 10A oriented differently in landscape orientation as a result of rotation by ninety degrees;

FIGS. 10C and 10D are close-up detailed views of FIGS. 10A and 10B respectively;

FIG. 11 shows an embodiment that functions, as per the other embodiments, even when the paper is oriented at forty-five degrees relative to the usually portrait or landscape orientations;

FIG. 12A and its enlarged view of FIG. 12B show a modified embodiment in which each intersection of the perpendicularly intersecting horizontal and vertical linear paths is free of any indications; and

FIG. 13A and its enlarged view of FIG. 13B is a variation of the embodiment of FIGS. 12A and 12B.

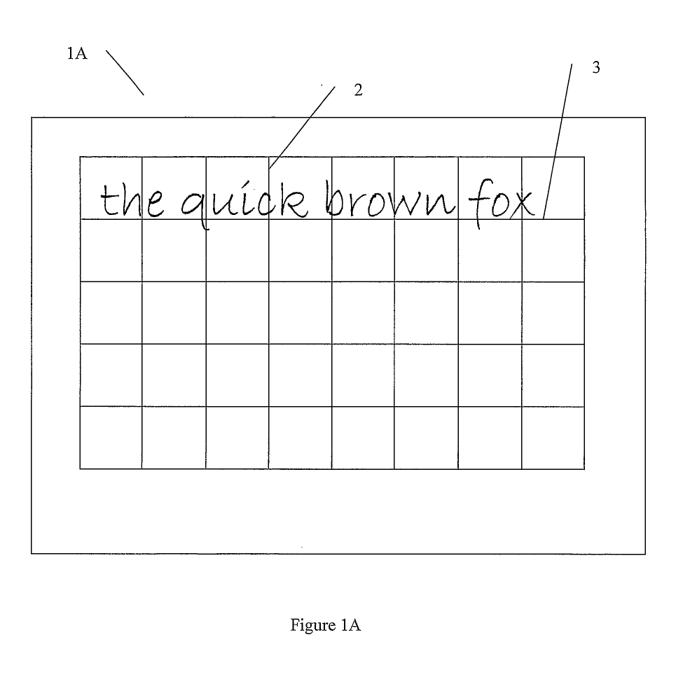

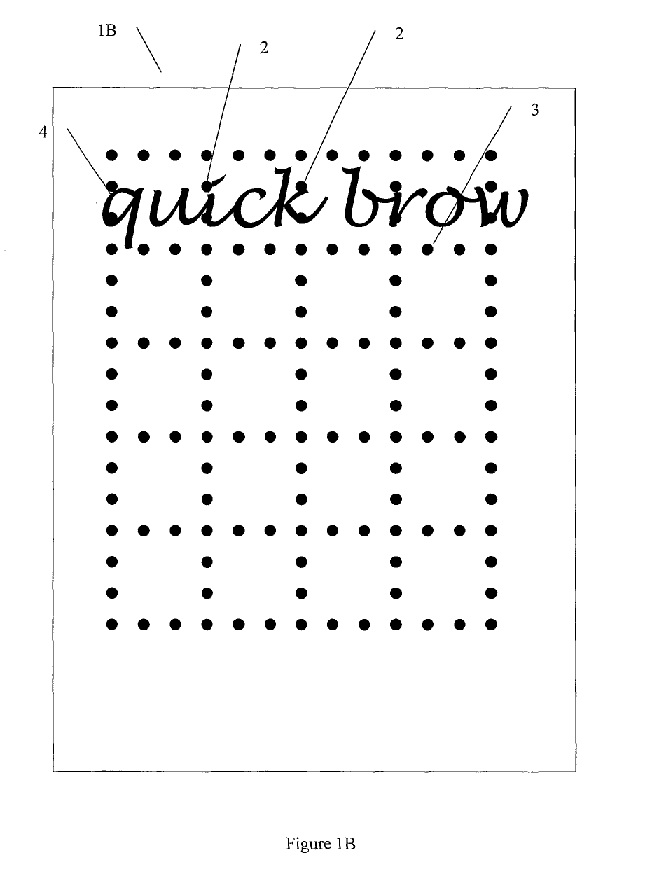

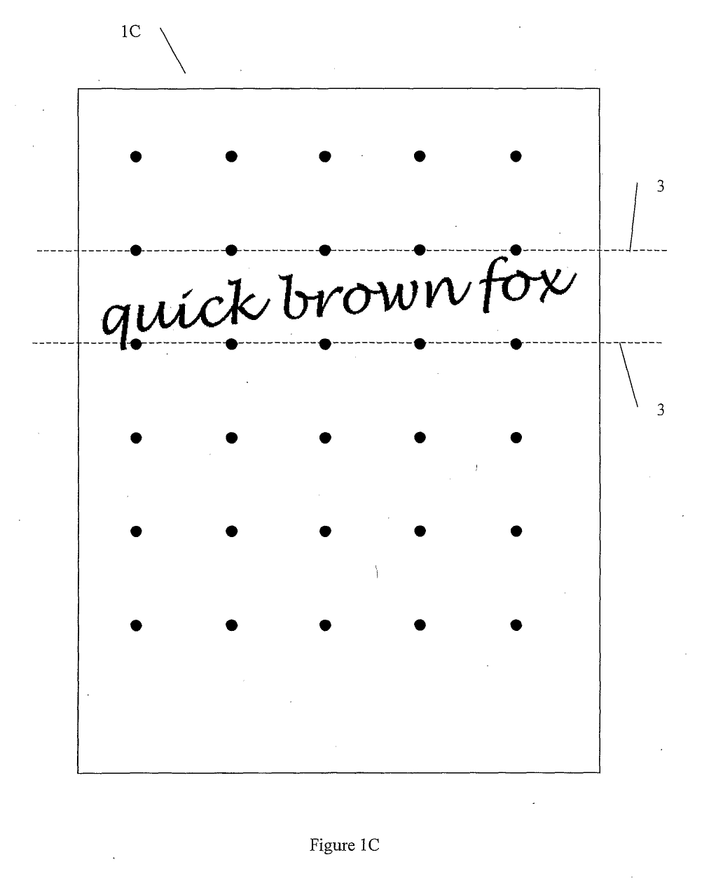

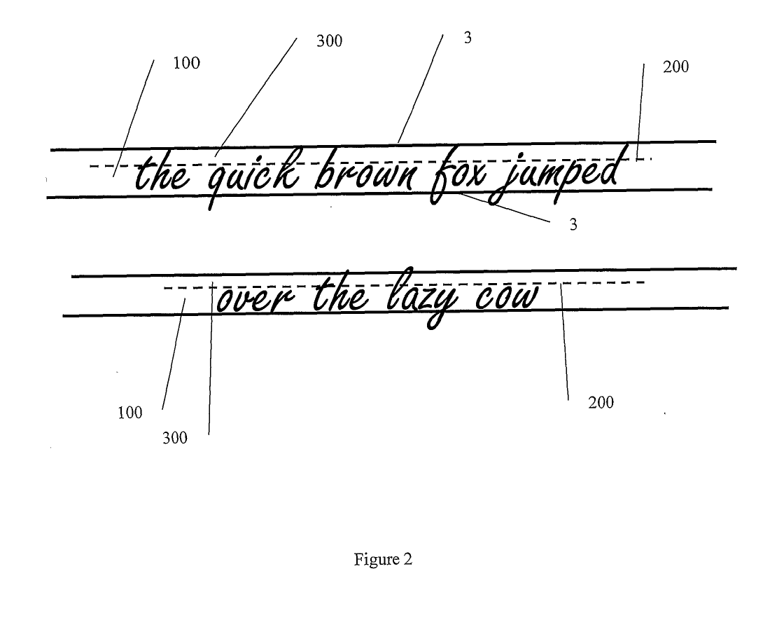

In the drawings, from the diagrams from FIG. 1 C onwards, the thin dotted lines—for example, reference numeral 3 in FIG. 1C, numeral 200 in FIG. 2 and numeral 3 in FIG. 3—are provided for illustrative purposes, and are not actually part of the pattern that appears visually on embodiments of the hand-inscribable surfaces.

In the drawings, similar features are labelled with like reference numerals merely for ease of understanding of the description.

### DESCRIPTION OF EMBODIMENTS

### Definitions

Before describing the embodiments in detail, reference is made to FIG. 2 which is used to indicate an example of handwriting that displays characteristics that are typical of English and other Roman-type handwriting.

In FIG. 2, most of the writing is found in a primary linear strip 100. In this primary strip 100, the bulk of the curved parts of the handwriting are located in typical handwriting.

Only a minority of the total amount of handwriting appears in a narrow secondary linear strip 300 that is in the upper portion of the space between the lines 3. In this secondary linear strip 300, a minority of handwriting appears, and it is mostly the stems of the handwriting that is found in this secondary region 300.

In this specification and the appended claims, the reference to majority and minority of handwriting can also be understood in terms of the comparative percentage of total ink, used in the handwriting, that is found in the primary strip 100 and the secondary linear strip 300.

Handwriting can be perceived to have a neat and attractive appearance when the tops of the curved portions of the letters are aligned with a boundary line 200 that defines the boundary between the primary 100 and secondary linear regions 300.

In English handwriting, the letters of the alphabet have curved portions, and they also have generally upright stem portions.

When the handwriting is Roman alphabet, the majority of typical handwriting generally comprises loops and circles of lower-case alphabet, while the substantial minority of typical handwriting generally comprises stems of the lower-case alphabet.

For example, in FIG. 2, the majority of the Roman alphabet handwriting consists of the curved portions, which are generally located below the boundary line 200. Only a small percentage of the handwriting appears above the boundary line 200, and these mostly consist of upright stem portions of the alphabetical characters. For instance, in the first line of FIG. 2, the letters T, H, K, B, F and D have upright stem portions which project generally above the boundary line 200.

Another small percentage of the stem portions appear below the lower main line 3. For example, in FIG. 2, the lower stem portions of the letters Q, F, J, P and Y project below the lower main line 3, and although some of these lower stein of these portions have curves, for this specification, these will be regarded as “stem portions”.

In this specification, the terms “curved portion” and “stem portion” will be used as per the manner in which these have been used in the two paragraphs above.

In FIG. 2, the boundary line 200 acts as a guide for the upper limit for the curved portions of the handwritten characters of the alphabet.

In typical handwriting, the boundary line 200 is usually found towards the upper region in the gap between the upper and lower lines 3.

Typically, in most people's handwriting, the boundary line 200 between the lower primary strip 100 and the upper secondary strip 300 tends not to be in the absolute middle of the lines 3.

To ascertain the optimum location of the boundary line 200, it may require the analysis of the handwriting of many people, however, the position of the boundary line 200, in between the main lines 3, is most likely to be around ⅔ to ¾ of the gap between the main lines 3.

In FIG. 2, the boundary line 200 is preferably towards the upper part of the gap between two of the lines 3.

### Clear Primary Linear Regions

In accordance with the above definitions, FIG. 3 shows a first embodiment of a hand-inscribable surface in the form of a patterned-paper 10A. The patterned-paper 10A is a piece of paper that has a pattern on its surface which assists a user to handwrite on the paper in correct alignment.

It is understood, however, that the invention is not limited to paper, pages or stationery, but can apply to other hand-inscribable surfaces such as blackboards or whiteboards.

The paper 10A is rectangular in shape, having a left vertical side edge, a right vertical side edge, a horizontal top edge and a horizontal bottom edge.

The pattern includes an arrangement of linear paths. The linear paths are in the form of solid lines 31 that lie along path-lines 3.

In between these path-lines 3 are linear regions in the form of in-between-spaces 40. The intention is that the user will handwrite substantially within these in-between-spaces 40, while relying on the path-lines 3 as an alignment guide.

### Discrete Indications

An important characteristic of the pattern, which is on the patterned-paper 10A, is that the pattern includes an arrangement of discrete indications. In the embodiment of FIG. 3, each of the discrete indications is in the form of a dot 30.

In the embodiments, each of the discrete indications is located in one of the in-between-spaces 40. Within its in-between-spaces 40, the dot 30 fulfils the function of demarcating a separation boundary 201.

In the embodiment, the separation boundary 201 is analogous to the boundary line 200 in FIG. 2.

In FIG. 3, the separation boundary 201 is indicated by a dotted line 201, which is represented on the drawing to show the linear arrangement of the dots 30, however, this thin dotted line 201 (which, in FIG. 3, passes through the dors 30) does not appear in the actual patterned-paper 10A.

In FIG. 3, the separation boundary 201 demarcates between two areas, namely:
i) a clear primary linear strip 101 which is substantially devoid of indications. In this clear primary linear strip 101, in use, a majority of typical handwriting will be inscribed; and
ii) at least one secondary linear strip 301 in which only a minority of typical handwriting will be inscribed.

In FIG. 3, the letters “r”, “o”, “w” and “n” are fully found in the primary linear strip 101. The letters “k” and “b” are substantially found in the primary linear strip 101, while the stems of the letters “k” and “b” protrude up into the secondary linear strip 301, and partly over the upper line 3.

When the user writes on the patterned-paper 10A, the separation boundary 201, which is indicated or suggested by the dots 30, acts as a guide for the user to neatly align the tops of the majority of lower-case letters, as shown in the example in FIG. 3.

### Location of the Separation Boundary

In the exemplary embodiment of FIG. 3, the separation-boundary 201 is substantially biased towards one of the linear paths, between which it lies. Each boundary 201 is located between two of the path-lines 3. The boundary 201, in FIG. 3, is closer to the upper of the two path-lines 3. In other words, it is further away from the lower of its two path-lines 3 of which it is between.

This biased positioning of the boundary 201, between its two path-lines 3 means that the boundary 201 is not located centrally between the two path-lines 3 between which it lies.

In the embodiments, the boundary 201 is biased so as to be closer to one of the two path-lines 3 between which it lies, with the limitation that the primary linear strip 101 must be substantially wider than the secondary linear strip 301. In other words, the primary linear strip 101 can never be narrower than the secondary linear strip 301. This is because the majority of the handwriting tends to occur within the primary linear strip 101, and not in the secondary linear strip 301.

The primary linear strip always takes up substantially more than 50% of the in-between-spaces 40. By saying that it is substantially more than 50%, it means that it has to be far enough away from the half-way point, so that a viewer would not at all perceive it as being at a half-way point. In embodiments, the primary linear strip 101 can take up around 66% or even 75% of the in-between-spaces 40.

The guiding factor that determines an optimum percentage, for the primary linear strip 101 to take up from the total area of the in-between-spaces 40, is where the majority of users will handwrite most of the upper limits for the curved portions of the handwritten characters of the alphabet. The primary linear strip 101 should take up sufficient percentage of the in-between-spaces 40 such that it allows a substantial majority of typical handwriting to be inscribed inside the primary linear strip 101.

In effect, the user who writes on first embodiment of the patterned-paper 10A, has an advantage of two alignment guides. The path-lines 3 act as overall alignment guides, while the separation-boundary 201 acts as a further alignment guide for the upper limit of the curved portions of typical handwriting. This could be helpful, for example, with children learning how to write neatly.

Linear Paths Formed by Indications Rather than Lines

FIG. 4 shows a second embodiment, which is similar to the first embodiment of FIG. 3 in all respects, except that FIG. 4 shows an embodiment of patterned-paper 10B in which the linear paths that are formed as rows 3 of discrete indications which are in the form of path-dots 31.

(In FIG. 4, the path-dots 31 have the same reference numeral “31” as the solid lines 31 in FIG. 3, to indicate that these are different embodiments of the same feature).

In the embodiment of FIG. 4, the arrangement of linear paths is formed as a grid-like pattern of discrete indications which lie on the linear paths.

The linear paths are formed as dots.

In the embodiment, the discrete indications of the arrangement of linear paths are visually identical with the discrete indications which demarcate the separation-boundary, i.e. they are all formed as identical dots.

The grid-like pattern of discrete indications comprises a plurality of perpendicularly intersecting horizontal linear paths 3 and vertical linear paths 3 which combine to form the grid-like pattern.

### Maintenance of Functionality in Different Orientations

By way of background, the embodiments of FIGS. 3 and 4 can only be used in one orientation, in the sense that, the pieces of patterned-paper 10A, 10B will not perform, as described above, if the paper 10A, 10B were to be rotated, for example, by 90 degrees.

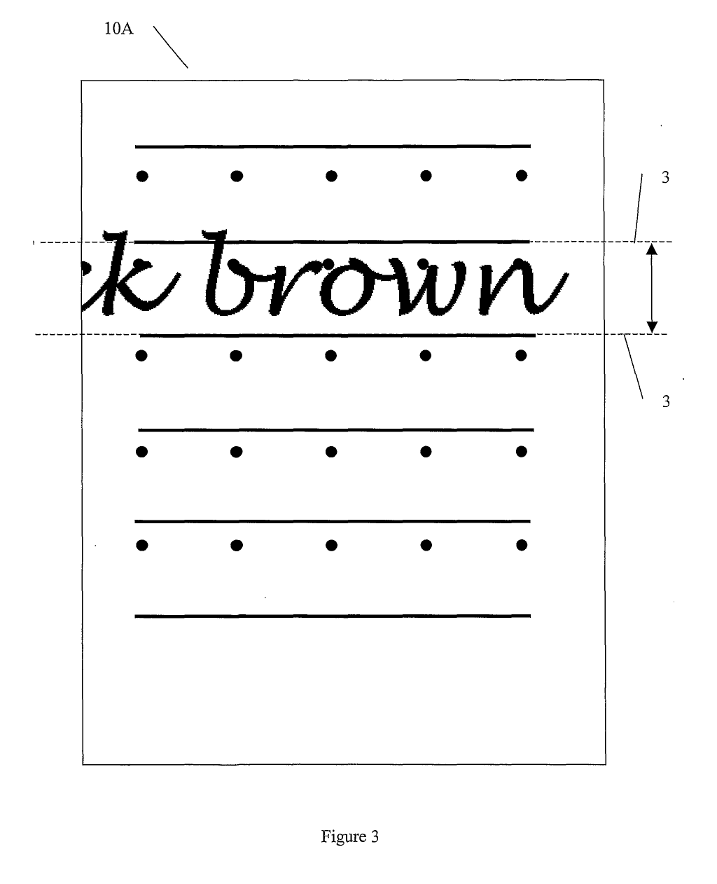

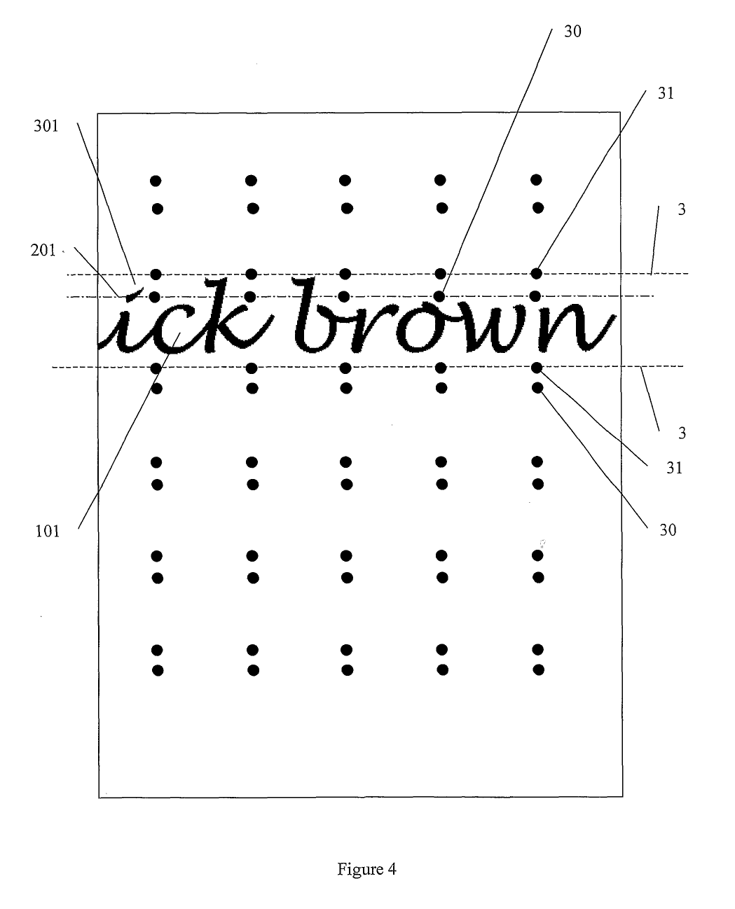

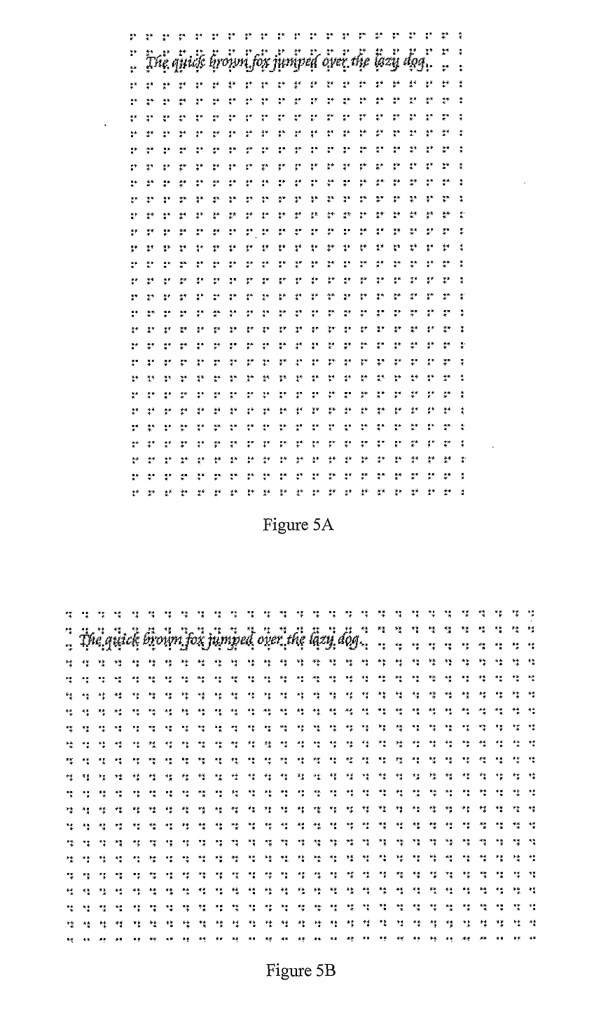

In contrast, FIG. 5A, and subsequent drawings, show embodiments in which the hand-inscribable surface is useable, with features as described, in at least a first and second orientation. In particular, in these embodiments, the feature of the clear primary linear strip 101 and secondary linear strip, both found within the linear regions, is the feature that is operational irrespective of whether the hand-inscribable surface is oriented in a first or second orientation. The ability for the feature to be operational in at least two orientations is achieved by the surface having a range of indications, some of which perform the function in the first orientation, while other of the indications perform the function in the second orientation.

In the embodiments, the paper is rotated into the second orientation by a rotation of ninety degrees from the first orientation. Other modifications of the pattern, however, can be designed to be rotated by other angles, such as thirty of forty-five degrees for example.

FIG. 5A (and the enlargement thereof in FIG. 5C) shows an embodiment of a patterned-paper 10C arranged in a first orientation, while FIG. 5B shows the same patterned-paper 10C rotated by ninety degrees into a second orientation.

The patterned-paper 10C is rectangular, and its pattern is operable when the paper is in either portrait or landscape orientation, shown respectively in FIGS. 5A and 5B.

In FIG. 5C, which is an enlarged view of part of FIG. 5A, some of the dots change their function when the paper orientation changes from the first orientation to the second orientation.

In particular, in the first orientation, some indications lie on the separation-boundary 201, whereas in the second orientation, those same indications lie on one of the linear paths that are formed as rows 3 of discrete indications which are in the form of path-dots 31.

For example, in FIG. 5C, the second dot 32 from the left, on the top line, functions as part of a main line 3. However, when the page is rotated by ninety degrees from the first orientation into the second orientation, there is a swapping of roles, in the sense that the same dot 32 now functions as part of one of the separation-boundaries 201. In other words, in different orientations, the same dot 32 performs a different role, depending on which of the two orientations the paper is oriented.

In summary, when the hand-inscribable surface is in a first orientation, some of the discrete indications which demarcate the separation-boundary are located on the vertical linear paths. Then, when the hand-inscribable surface is rotated ninety degrees into a second orientation, there is a swapping of roles in that those same discrete indications are then located on the horizontal linear paths wherein they perform the role of defining the horizontal linear path.

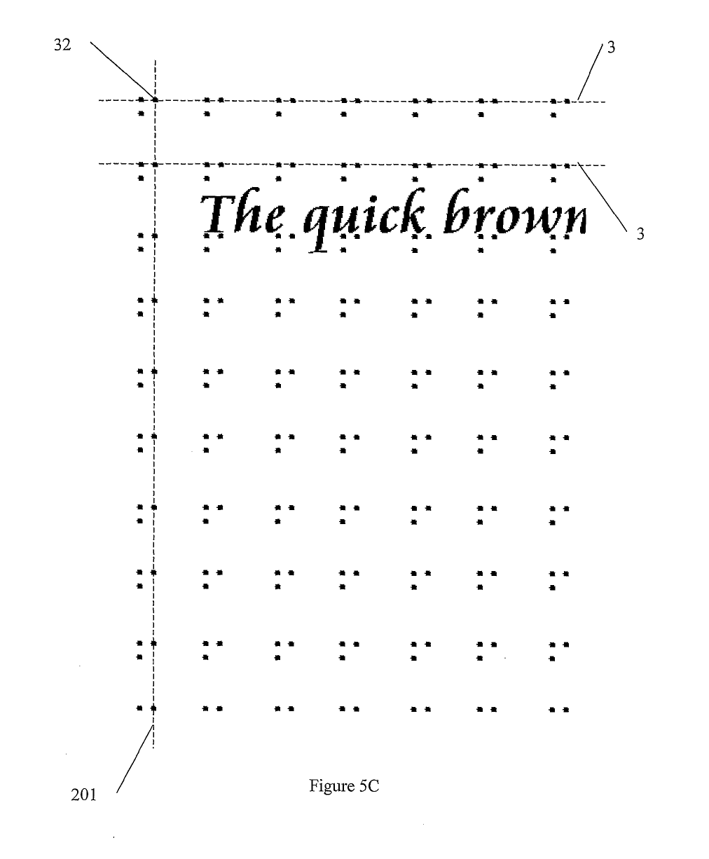

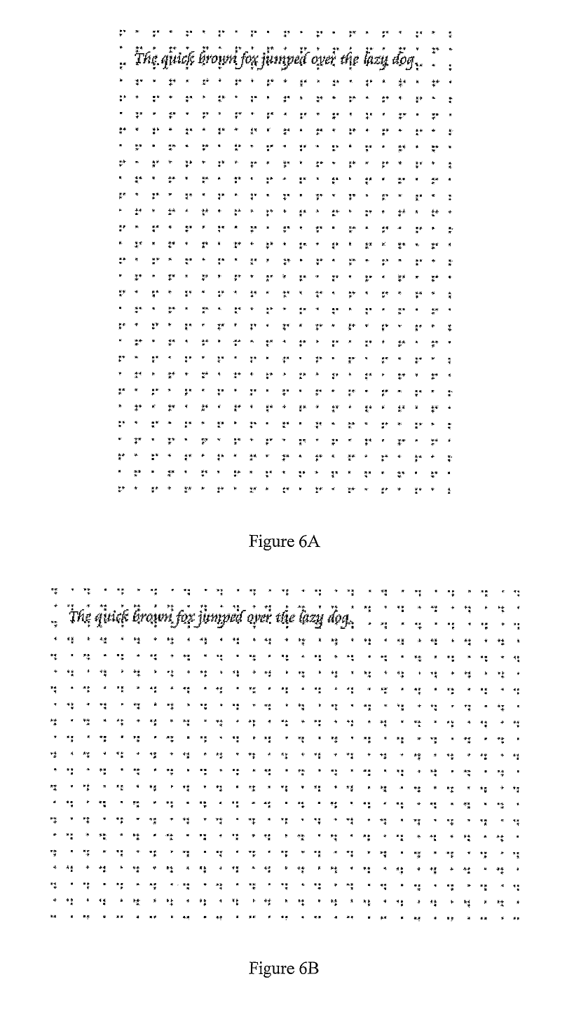

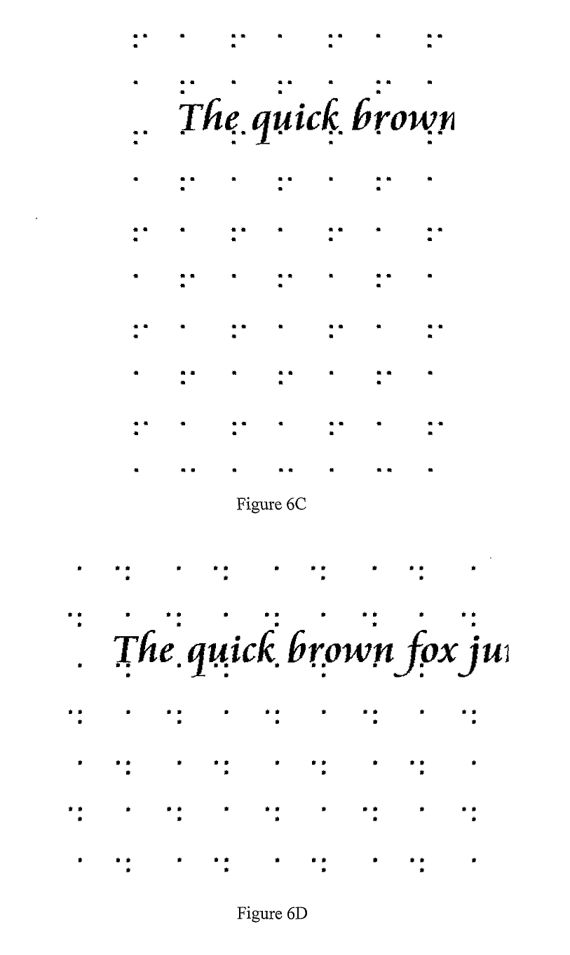

This ability to retain the functionality of the pattern on the paper, when the paper is oriented in either of at least two orientations, is also seen in other embodiments in FIGS. 6A onwards.

In other embodiments, the paper can retain functionality in three or more orientations.

### Grid Characteristics

In most of the embodiments from FIG. 4 onwards, the grid-like pattern includes a discrete indication, in the form of a dot 31, located at each intersection of the perpendicularly intersecting horizontal and vertical linear paths 3.

In the embodiments of FIGS. 6A-D, 7A-D and 8A-D, the dots which are located at some or each of the intersections, along with adjacent indications which demarcate the separation-boundary, together form a V-shaped pattern.

One might imagine these V-shaped patterns as the pointed-ends of arrows.

In FIGS. 6A-D, the V-shaped pattern is defined at every intersection of the perpendicularly intersecting horizontal and vertical linear paths.

In other modifications, there is variation as to whether these V-shaped patterns occur at all or only some of the intersections.

For example, in the embodiment in FIGS. 6A-D, the V-shaped pattern does not occur at all intersections. Instead, the V-shaped patterns are only defined at alternate intersections of the perpendicularly intersecting horizontal and vertical linear paths. In FIGS. 6A-D, those intersections that are not provided with the V-shaped patterns merely have a single dot at that intersection.

### Difference in Indication Intensity

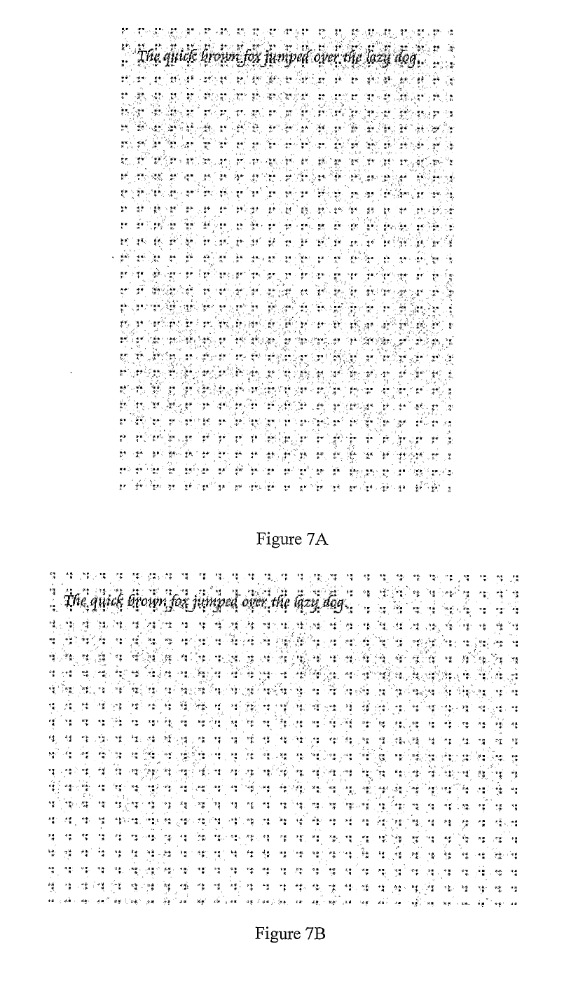

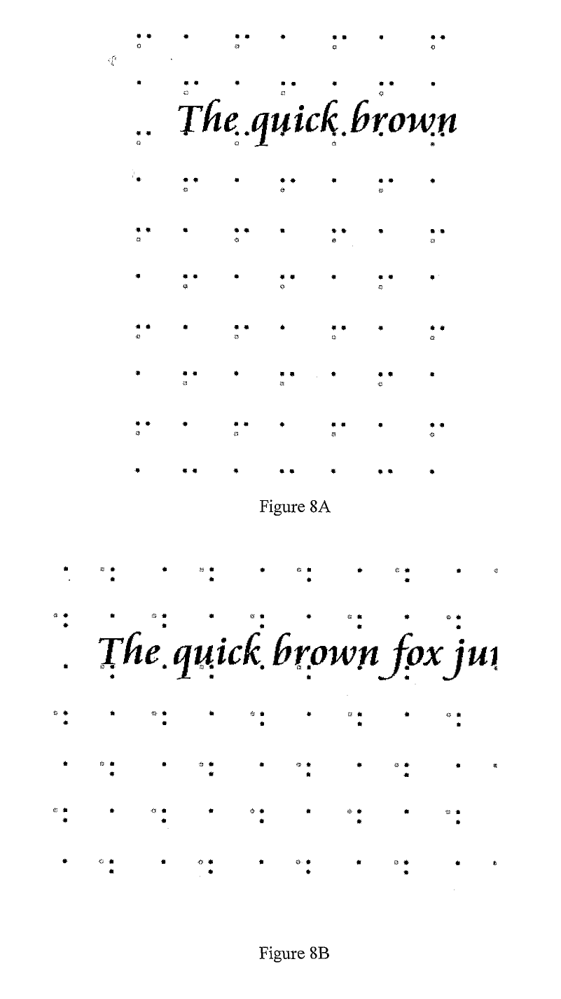

In other examples, in the embodiments in FIGS. 7A-B and FIGS. 8A-B, there is a difference in intensity of the dots, in order to more clearly communicate to the user about the differences in the roles of the various sets of indications.

For example, in FIG. 7A, the separation boundary 201 are of a lighter shade compared to the dots which make up the horizontal linear paths 3. When this same paper is rotated through ninety degrees, as shown in FIG. 7B, the lighter-coloured dots function as part of the horizontal linear paths 3, while some of the darker dots function as part of the separation boundary 201.

FIGS. 8A and 8B show another example where there is a difference in intensity of the indications. In these drawings in FIGS. 8A and 8B, only each alternate intersection is provided with the V-shaped pattern of indications. In FIG. 8A, the dots which function as the separation boundary 201 are lighter in intensity. When this piece of paper is rotated by ninety degrees, in FIG. 8B, the lighter dots are oriented so as to function as part of the horizontal linear paths 3.

The difference in intensity can be created by differences in shade or colour. The difference can also be achieved by representing each of the indications differently, for instance, the indications at the intersections could be in the form of tiny stars, whereas the indications at the separation boundary could be in the form of tiny squares. In other words, the embodiments are not limited to a particular manner of achieving a visually-discernible difference in the functionally different indications.

Variation of intensity can be used to create discernible patterns or illustrations that arise from the colour scheme of the discrete indications. For instance, colour variation can be used to create a company logo, or even a faint watermark. In addition to colour variation, there can be variation of the intensity or depth of colour. The variation of tint of colour and/or intensity of colour can be used to create discernible patterns or images.

### Further Arrangements of Indications

In the embodiments of FIGS. 6A-D and FIGS. 7A-D, in each orientation of the paper, all the V-shaped patterns point in the same direction.

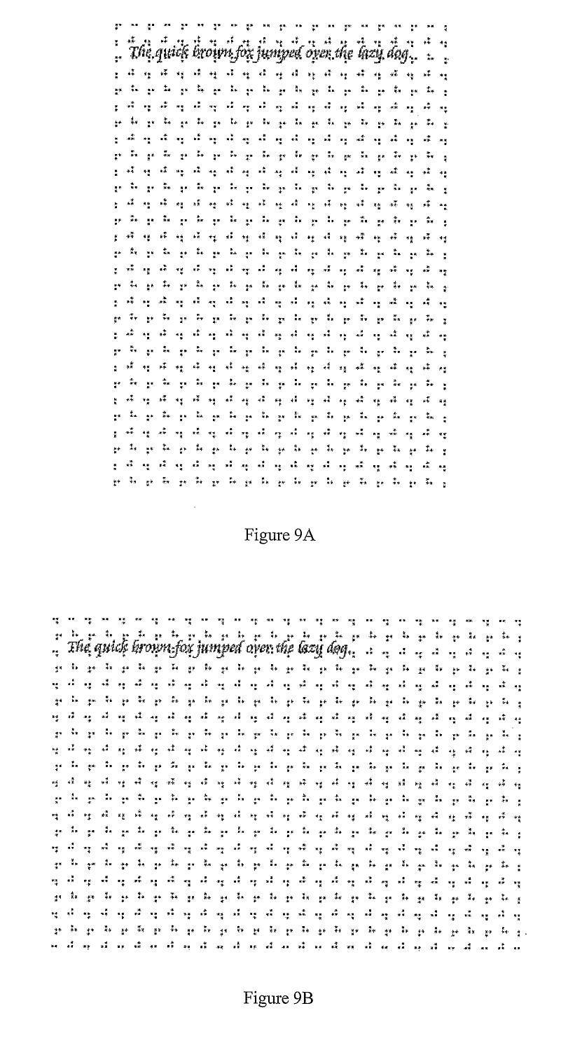

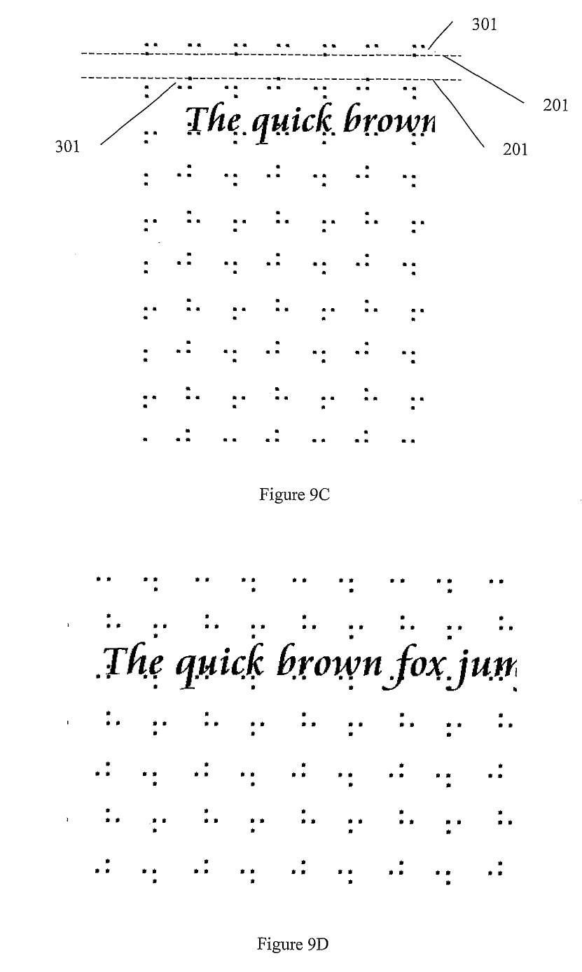

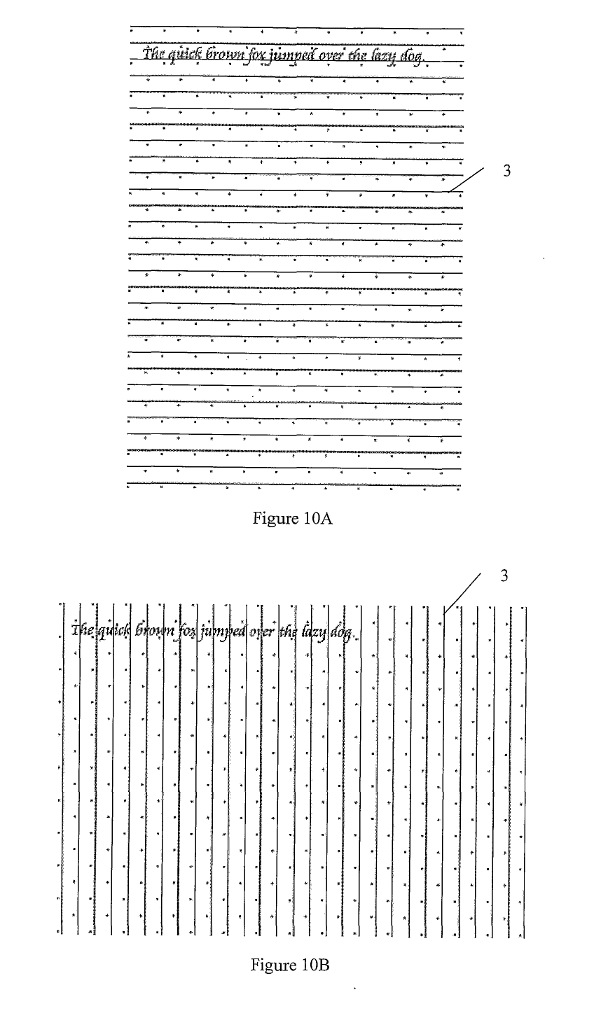

In contrast, in the embodiment of FIGS. 9A-D, some of the V-shaped patterns point in one direction while other of the V-shaped patterns point in a different direction.

In FIGS. 9A-D, every alternate, or every second intersection point is provided with a V-shaped pattern that points in the same direction. In between each of these V-shaped patterns is one of another series of V-shaped pattern that points in a direction that varies by ninety degrees.

FIGS. 9C and 9D are close-up views respectively of FIGS. 9A and 9B.

In contrast to earlier embodiments, the modification in FIGS. 9A-D are characterised in that the pattern of discrete indications demarcates the separation-boundary between the clear primary linear strip and two secondary linear strips. For example, in the enlarged view of FIG. 9A, the paper has two separation boundaries 201 which create two secondary linear strips 301. There are upper and lower separation-boundaries 201.

### Combination of Indications and Lines

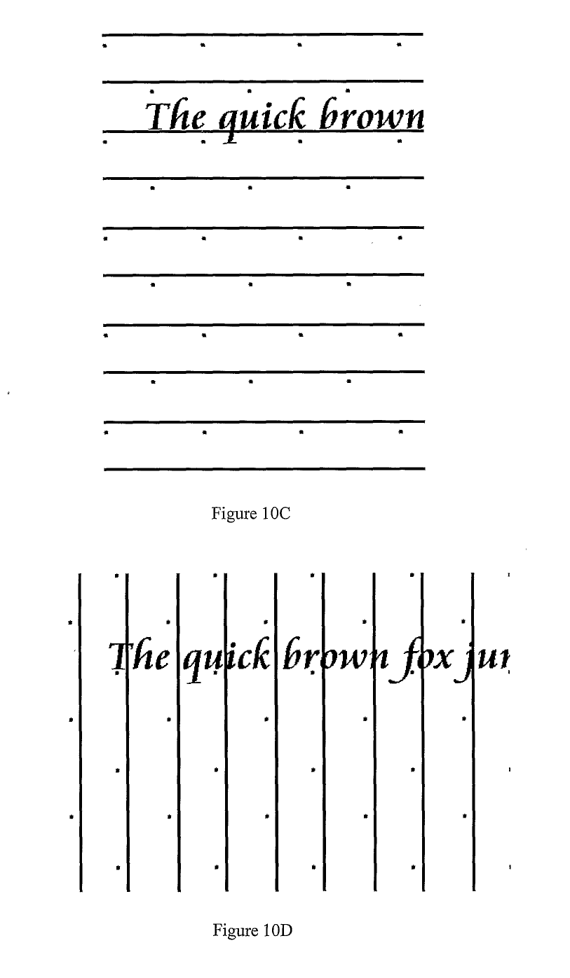

A further embodiment is shown in FIGS. 10A and rotated FIG. 10B, and the corresponding enlarged views of FIGS. 10C and 1D respectively. In this embodiment, in a first orientation, the linear paths are in the form of solid lines 3, akin to the embodiment in FIG. 3.

However, in the embodiment in FIGS. 10A-D, every second indication, in the separation-boundary, is omitted in a manner that is akin to the embodiment in FIG. 6A.

Also, as can be seen from the drawings in FIGS. 10A-D, the arrangement of the dots in the separation-boundary is such that dots form diagonal paths. These notional diagonal paths are arranged at forty-five degrees with respect to the solid lines 3.

### Diagonal Writing Guide

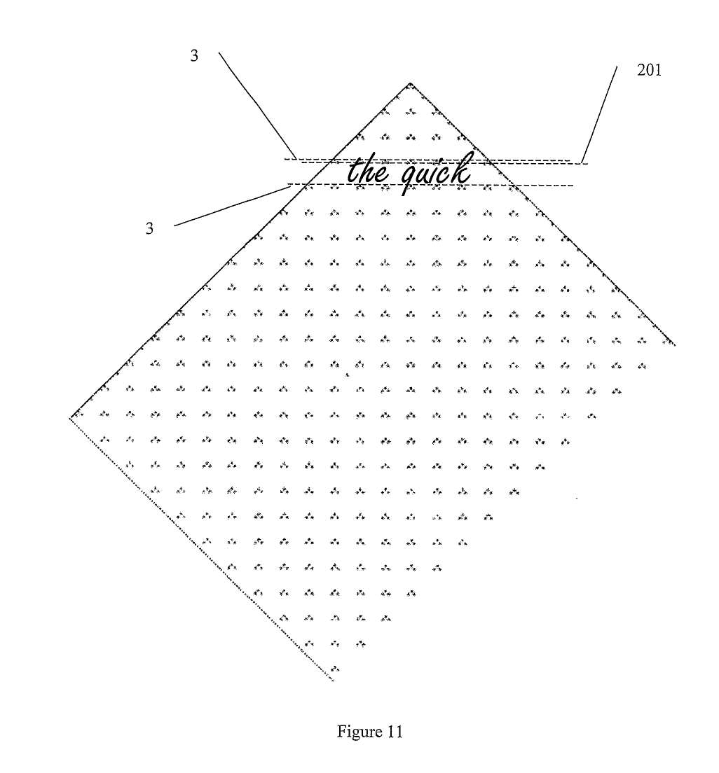

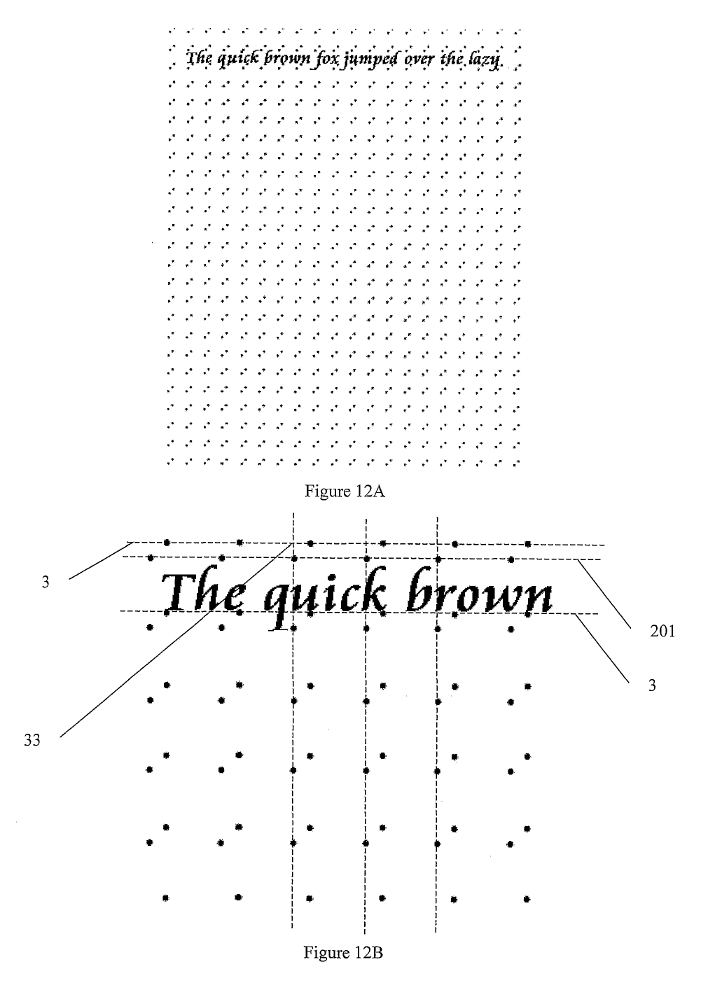

FIG. 11 shows an embodiment which can be used in a third orientation. In this embodiment, the arms of the V-shaped patterns are inclined, pointing south-east and south-west.

In FIG. 11, when the paper is oriented at forty-five degrees to the usual portrait or landscape, a separation-boundary 201 is arranged as a result of the dots of the V-shaped patterns. The separation-boundary 201 is, once again, substantially biased towards one of the linear paths, between which it lies. Each boundary 201 is located between two of the path-lines 3. The boundary 201, in FIG. 11, is closer to the upper of the two path-lines 3. In other words, it is further away from the lower of its two path-lines 3 of which it is between.

This biased positioning of the boundary 201, between its two path-lines 3 means that the boundary 201 is not located centrally between the two path-lines 3 between which it lies.

Hence, the embodiment in FIG. 11 functions in a similar manner to the other embodiments to provide a writing guide for the user.

### Omitted Indications

In contrast to the embodiments, which have dots located at each intersection of the perpendicularly intersecting horizontal and vertical linear paths 3, other modifications can have an arrangement where each intersection of the perpendicularly intersecting horizontal and vertical linear paths is free of any indications.

FIG. 12A, and its enlarged view of FIG. 12B, show a modified embodiment in which each intersection of the perpendicularly intersecting horizontal and vertical linear paths is free of any indications.

In the enlarged view of FIG. 12B, even without an indication at each intersection 33, the user still is able to perceive a separation-boundary 201 that is arranged as a result of the other dots. The separation-boundary 201 is, once again, substantially biased towards one of the linear paths, between which it lies. Each boundary 201 is located between two of the path-lines 3. The boundary 201, in FIG. 12B, is closer to the upper of the two path-lines 3. In other words, it is further away from the lower of its two path-lines 3 of which it is between.

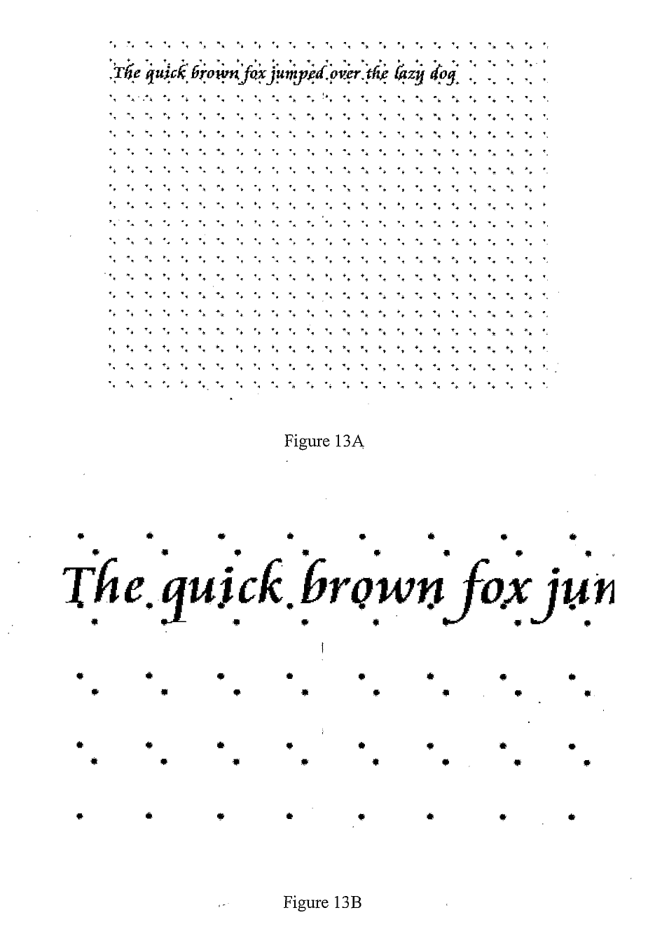

FIG. 13A and its enlarged view of FIG. 13B is a mirror-reflection variation of the embodiment of FIGS. 12A and 12B.

In FIGS. 12A and 13A, all the intersections are provided with an indication, however, in other modifications, some of the intersections can be free from indications, to such an extent that the ability of the user to see the functionality of the pattern is still maintained, even though some indication at some of the intersections are omitted.

### Modification of Indications

In the illustrated embodiments, each discrete marking is a dot, however, in other variations, some or all of the discrete indications are in the form of minute symbols or shapes, including alphabetic characters, numerals or other minute symbols or geometrical shapes. The indications may also be in the form of very small lines or discrete dashes each substantially distanced from one another.

The indications may be provided in one colour, or in a plurality of colours.

The indications may be in the form of faintly discernible watermarks on the surface of the paper, so as to be less obtrusive.

The indications may also be actual consist of physical variations in the surface of the paper, such as in the form of indentations or protrusions.

In the embodiments, the arrangement of indications would preferably cover the area where a user would expect to write on the surface, particularly in the region where lines would appear on conventional lined-paper. However, the indications may cover all of the sheet, or only part. The indications may or may not appear in the edge margins of the paper.

Distinction between the indications and the overall surface of the paper can also be achieved, for example, by the differences in matt or gloss finish. For instance, the surface of the paper could have a general matt finish, while the indications could be provided in a gloss finish.

In some variations, the indications are provided in a plurality of shades.

### Examples of Size and Dimensions

The exemplary embodiment is made from 80 GSM printing paper. In this example, the guide indications are applied to only one surface of the paper using a printer. The guide indications, in the form of dots, combine to create a square grid pattern on the paper. Each dot is substantially equal thickness, and substantially equal spacing from the next nearest dot, and each is substantially the same colour as the others. The dots are approximately 0.5 mm in diameter. The indications are light grey in colour so as to be faintly visible, but inconspicuous. All these parameters in the exemplary embodiment can be modified within the scope of the invention.

Preferably, the dots may be around half the size of the anticipated normal tip of a writing implement, such as a pencil or pen. For paper, the dots may be around 0.5 mm. For a white board which uses 2 0 mm marker pens, the dots may be around 1.0 mm or slightly larger.

Determining the size of the dot-size for a particular embodiment may also be influenced by the distance between the lines, i.e. the size of the in-between-spaces 40. For example, the ratio of line-gap to dot-size would be in the range of 12:1 through to 20:1, as an example. This allows the dots to be effective as alignment guides without making them too intrusive in the appearance of the inscribable surface.

When the paper is used for handwriting, the rows of discrete indications are less conspicuous compared to the kind of solid horizontal lines common in the prior art. When the paper 10 contains a lot of handwriting, the tiny dots are very inconspicuous, certainly far less conspicuous than horizontal lines found in ruled paper in the prior art. (In the drawings, the size of dots has been exaggerated for the purpose of illustration).

The inconspicuousness of the discrete indications, of the present embodiment, is particularly advantageous when the written paper is subsequently photocopied. The indications can be made even less-visible in the subsequent photocopy by creating the indications in a colour or texture that does not photocopy as readily.

In the preferred embodiment, the dots are small enough so as not to be a visual distraction, but the dots are large enough to be visible to the user during the hand-inscribing process in order to act as alignment guides.

In the embodiment, all of the discrete indications are of the same size, however, in other modifications the sets of indications can include discrete indications that cover a range of sizes. This latter embodiment may be useful when using the variation in the indications to create patterns, or images on the surface that are discernible to the user. These patterns or images may be commercial logos or the like, or can have a functional purpose in guiding the user to draw or write in a certain manner. Alternatively, the patterns or images may simply be decorative.

Embodiments of the invention may be used on inscribing surfaces or writing surfaces, for example, regular stationery, notepads, notebooks, envelopes (front and back, exterior and interior surfaces), index cards, sketching and drafting pads, whiteboards, blackboards, poster paper, letterheads, printer paper, to name a few. The invention can also be applied to the either or both side(s) of business cards which may be used for making notes.

The arrangement of indications may be provided on the surface for a primary use as an inscribing or writing surface, such as writing paper. Alternatively, the arrangement of indications can be provided on surfaces that are not primarily intended for writing, but can be so used for writing as scrap paper, for instance on envelopes that have been sent through the mail.

In the specification, the expression “hand-inscribable” covers all manner of hand-scribing including writing, drawing, sketching, and it also includes writing of words, and also the inscribing of symbols, drawings, shapes, diagrams etc.

The inscribing can be performed by any inscribing means or implement, such as pens, pencils, markers, crayons, chalk, paint, to name a few.

In its broadest aspect of the invention, the discrete indications can be of any size, shape, colour, hue or shade, provided that they together form an arrangement of rows of discrete indications that act as an alignment guide for hand-inscribing on the surface, particularly for writing. Variation of these parameters of the indications can be used to endow the surface with different characteristics of appearance or function.

In other variations, rather than having a square grid where the inter-line distance is the same for the first and second set of rows, the modification can be that the inter-line distance of the first set differs from that of the second set. This would lead to a modified embodiment that had the appearance of a rectangular grid, rather than a square grid.

The invention in its broadest aspect is not limited to any particular method of applying or creating the discrete indications to the surface. In the embodiment, the indications are printed on the surface, but they can be applied by photographic or other processes, even through dyeing processes.

In various sheet-like embodiments, the indications can be applied to only one side of the surface, or to both sides of the sheet.

Embodiments of the invention are particularly useful for users who need to plot graphs, as well as write words on the same surface of paper. Such embodiments would have the benefit of having a grid that aids the user to plot the graph, while the clear primary linear strips, on the sheet, make the embodiments more suitable to writing. This is in contrast to prior art, conventional graph paper that has markings on the paper, between the lines, where a majority of typical handwriting would be inscribed.

### Other Modifications

In this specification, where the words comprise or comprises or derivatives thereof are used in relation to elements, integers, steps or features, this is to indicate that those elements, steps or features are present but it is not to be taken to preclude the possibility of other elements, integers, steps or features being present.

The embodiments have been advanced by way of example only, and modifications are possible within the scope of the invention as defined by the appended claims.

It is noted that copyright ownership is asserted in relation to the design, pattern and/or ornamentation particularly in relation to the accompanying drawings relating to embodiments of the present invention.

1. A hand-inscribable surface provided with a pattern on the surface to assist a user to handwrite thereon in correct alignment, the pattern including:
an arrangement of linear paths with linear regions therebetween such that the user is able to handwrite in the linear regions while relying on the linear paths as an alignment guide,
wherein the pattern on the surface includes an arrangement of discrete indications which demarcate, within its linear region, a separation-boundary between:
i) a clear primary linear strip which is substantially devoid of indications and in which clear primary linear strip, in use, a majority of typical handwriting will be inscribed; and
ii) at least one secondary linear strip in which only a minority of typical handwriting will be inscribed,
and wherein the separation-boundary is substantially biased towards one of the linear paths, between which it lies,
and wherein the separation-boundary is not located centrally between the linear paths between which it lies.
and wherein the primary linear strip is substantially wider than the at least one secondary linear strip.

2. A surface of claim 1 wherein the primary linear strip takes up substantially more than 50% of the linear region.

3. A surface of any one of the preceding claims wherein the separation-boundary acts as a further alignment guide for the upper limit of the curved portions of typical handwriting.

4. A surface of any one of the preceding claims wherein the hand-inscribable surface is useable in at least a first and second orientation, wherein the first orientation is rotated with respect to the second orientation.

5. A surface of claim 4 wherein the first orientation is rotated by 90 degrees from the second orientation.

6. A surface of claim 5 wherein the hand-inscribable surface is rectangular, and the pattern is operable as defined when the rectangular surface is in either portrait or landscape orientation.

7. A surface of any one of claims 4 to 6 wherein, in one orientation, some indications lie on the separation boundary,
and wherein, in a second orientation, said some indications lie on a linear path.

8. A surface of claim 5 wherein the first orientation is rotated by 45 degrees from the second orientation.

9. A surface of claim 4 wherein, when the hand-inscribable surface is in the first orientation, some of the discrete indications which demarcate the separation-boundary are located on the vertical linear paths, and when the hand-inscribable surface is rotated by an amount of degrees into the second orientation, there is a swapping of roles in that the aforesaid discrete indications are then located on the horizontal linear paths wherein they perform the role of defining the horizontal linear path.

10. A surface of claim 9 wherein the amount of degrees is ninety degrees.

11. A surface of claim 9 wherein the amount of degrees is forty-five degrees.

12. A surface of any one of the preceding claims wherein the linear paths are formed as a linear row of dots.

13. A surface of any one of the preceding claims wherein the discrete indications of the arrangement of linear paths are visually identical with the discrete indications which demarcate the separation-boundary.

14. A surface of any one of the preceding claims wherein the arrangement of linear paths is formed as a grid-like pattern of discrete indications which lie on the linear paths.

15. A surface of claim 14 wherein the grid-like pattern of discrete indications comprises a plurality of perpendicularly intersecting horizontal and vertical linear paths which thereby form said grid-like pattern.

16. A surface of claim 14 or 15 wherein each intersection of the perpendicularly intersecting horizontal and vertical linear paths is free of any indications.

17. A surface of claim 14 or 15 wherein some of the intersections of the perpendicularly intersecting horizontal and vertical linear paths is free of any indications.

18. A surface of claim 14 or 15 wherein the grid-like pattern includes a discrete indication located at some or each intersection of the perpendicularly intersecting horizontal and vertical linear paths.

19. A surface of claim 18 wherein the discrete indication located at some or each of the intersections, along with adjacent indications which demarcate the separation-boundary, together form a V-shaped pattern.

20. A surface of claim 19 wherein said V-shaped pattern is defined at alternate intersections of the perpendicularly intersecting horizontal and vertical linear paths.

21. A surface of claim 19 wherein said V-shaped pattern is defined at every intersection of the perpendicularly intersecting horizontal and vertical linear paths.

22. A surface of any one of claims 19 to 21 wherein all the V-shaped patterns point in the same direction.

23. A surface of any one of claims 19 to 21 wherein some of the V-shaped patterns point in one direction while other of the V-shaped patterns point in a different direction.

24. A surface of any one of the preceding claims wherein, when the handwriting is Roman alphabet, the majority of typical handwriting generally comprises loops and circles of lower-case alphabet, while the substantial minority of typical handwriting generally comprises stems of the lower-case alphabet.

25. A surface of any one of the preceding claims wherein the linear regions include one or two secondary linear strips.

26. A surface of claim 25 wherein the pattern of discrete indications demarcates the separation-boundary between the clear primary linear strip and two secondary linear strips.

27. A surface of claim 26 wherein linear regions include two separation boundaries.

28. A surface of any one of the preceding claims wherein the surface is a piece of paper, a stationery item or a whiteboard writing surface.

29. A surface of any one of claims 1 to 28 wherein all of the discrete indications are in the form of dots.

30. A surface of any one of claims 1 to 28 wherein some or all of the discrete indications are in the form of minute symbols including alphabetic characters or numerals.

31. A surface of any one of the preceding claims wherein the indications are provided in one colour, or a plurality of colours.
